(19) United States
(12) Patent Application Publication
(10) Pub. No.: US 2026/0302980 A1
(43) Pub. Date: Oct. 1, 2026

(54) EMOTOR CURRENT SAMPLING ARRANGEMENT

(71) Applicant: Silicon Mobility SAS, Valbonne (FR)

(72) Inventors: Sylvain RODHAIN, Valbonne (FR); Farid TAHIRI, Valbonne (FR); Khaled DOUZANE, Grasse (FR)

(21) Appl. No.: 19/479,762

(22) PCT Filed: Jun. 5, 2023
(86) PCT No.: PCT/EP2023/064960

§ 371 Date: Oct. 29, 2025

(51) Int. Cl. H02P 21/14; H02P 27/06

(52) U.S. Cl. CPC H02P 21/14; H02P 27/06

(57) ABSTRACT

A regulating arrangement for electric motor control, including: a motor position measurement device configured to generate position measurements; a trigger device configured to generate trigger signals; a motor inverter current measurement device configured to provide current measurements in response to trigger signals; and a regulating device configured to generate regulating signals using the current measurements and/or the position measurements, and to provide input signals to the trigger device.

### CROSS-REFERENCE TO RELATED APPLICATION(S)

This application is a national phase of International Application No. PCT/EP2023/064960 filed on Jun. 5, 2023, the entire contents of which is incorporated herein by reference.

### FIELD OF THE INVENTION

The invention relates to regulating arrangements, control arrangements, motor arrangements and methods that can be employed therewith

### SUMMARY OF THE INVENTION

This invention applies in the context of electric machine digital control algorithm and more specifically to the Field Oriented Control (FOC) regulation of synchronous electric motors. The invention addresses the difficulty of sampling the motor phase currents while using an OPP (Optimized Pulse Patterns) modulation, very different from the standard pulse width modulations (SVPWM or DPWM).

In this context, the “modulation” is the digital function that allows the generating of close to sinusoidal current waveforms in the electric motor coils, through a multi-phase inverter module as shown in FIG. 1. The phase currents are feedback information of paramount importance and are the main input signals for the regulation.
(0101): Digital control system
(0102): Electric motor power stage (e.g. Inverter), also further called gate signal generating device.
(0103): Electric motor (e.g. with 3 phases, other phase's topology being supported)
(0104): Motor phase current sensors
(0105): Battery power line
(0106): Transistors controlled by the digital logic
(0107): Motor position sensor

The problem to be solved when using FOC as shown in FIG. 2 is that the individual phase currents measurements are aggregated to obtain, in a rotating frame, the DQ-frame, the equivalent global current vector applied to the EMotor. This aggregation uses the Clarke and Park transformations and requires the phase currents to be sampled simultaneously and associated with the corresponding instantaneous electrical position. Each phase current, due to the discontinuous control signals applied to the power stage, exhibits, while on average following a sinusoidal waveform, additional ripple. In the DQ-frame, all individual phase current ripples are superimposed becoming a combination of all disturbances. The typical electrical motor modulation is a pulse width modulation (SVPWM or DPWM), having pulses and notches relatively centered on all three phases. The sampling points are predictably centered on the pulses (and/or the notches) of the control signals applied to the inverter gates and possess the remarkable property of being free from any ripple, as they occur when the phase currents precisely cross the fundamental of the waveform. Hence this modulation provides the capability of periodically sampling simultaneously all phase currents, free from any undesired disturbance (ripple).

Because OPP have freely placed switching positions for controlling the gates of the power stage, the OPP modulation will not necessarily provide the opportunity to sample all phase currents simultaneously free from any ripple disturbance. Moreover, when a specific OPP pattern provides simultaneous sampling points of all phase currents without ripple, those sampling points are not timely periodic but may be spread at specific electric angular positions. Those sampling instants are related to the angular position and consequently dependent on the speed and on the acceleration, not upon the time.

During regulation, the applied OPP pattern might change, rendering any stationary prediction of the sampling instants improper.

The FIG. 2 presents the electric motor control principles with:
0201: FOC algorithm
0202: Modulation either SVPWM or OPP, further also called modulating device.
0203: Transistor gate signals generation for power stage control
0204: Three phases current measurement from the motor
0205: Clarke transformation: to transform I_{A, B, C} currents to I_{alpha, beta}
0206: Park transformation: to transform I_{alpha, beta} currents to I_{D, Q} currents
0207: Regulation of I_{D} and I_{Q} currents
0208: Motor position measurement

The objective is to have a proper acquisition stage, that will enable the control signals, the EMotor currents in the DQ-frame, called I_{D} and I_{Q} to be used for the regulation block, ensuring a proper stationary (respectively dynamic) behavior of the motor, with a stable current control (respectively following any and up to the harshest scenario).

When tackling those objectives, one runs in various problems as described below.

Not having the phase currents to all simultaneously cross their fundamental, can be solved by sampling them when I_{D} and I_{Q} cross their respective representative values.

That is, despite having measured ripple in each phase currents, once transformed into the DQ-frame, ripples of the various phases will cancel each other out so there is no disturbance left in the DQ-frame.

Even when considering only the I_{D} and I_{Q} signals directly, the availability of simultaneous sampling instants is not ensured and depends only on the pattern being played.

Sampling the phase currents to compute independently I_{D} from I_{Q} (when each signal predictably crosses its average value) would double the number of required computations, alongside injecting asynchronism in the two regulation branches.

When regulating the motor and especially during dynamic scenarios, the expected sampling instants are slightly shifted, due to accelerations/decelerations of the motor. Given that the slopes of phase current ripples of I_{D, Q} can be up to 1e6 A/s, the slightest temporal (or angular) error in the sampling instant results in major measurement error.

During regulation, the played OPP pattern is regularly updated to ensure the modulation ratio correctness, along with the phase voltage changing (equivalent to shifting the pattern forward or backward in angular position).

Both those mechanisms, which ensure the stability of the regulation, render difficult if not impossible, the prediction of sampling instants.

FIG. 3 shows how this is tackled by the prior-art.
(0601): Periodic timer initiating triggers for the sampling and for the modulation update.
(0602): Trigger to sample phase currents.
(0603): Trigger to estimate the EMotor angular position.
(0604): Update of the modulation, using conclusive measurements and calculations of the previous sampling iteration.
(0605): Simultaneous sampling of all phases current upon a trigger.
(0606): Field oriented control computation executed after each phase currents sampling.
(0607): Periodic timer for the position estimation

FIG. 4 shows the corresponding results of that
(0401): Phase potentials exhibit pulses centered upon all phases.
(0402): Phase currents exhibits, on average, a sinusoidal waveform with some ripple disturbances.
(0403): Upon every PWM period, at start and in the middle of the period (e.g. here every 50 us), the phases currents cross their average sinusoidal waveform, making it a perfect simultaneous sampling point.

The prior-art solution causes a variety of problems as outlined below:

Due to the nature of OPP modulation, in its effect on the phase current, the temporal periodic sampling technique is highly inadequate, unless adding strong constraints on the patterns' generation: this directly contradicts our approach of OPP pattern generation, with as few constraints as possible enforced during pattern generation.

The traditional Pulse Width modulation enables the regulated modulation ratio (or duty cycles) to change widely from one period to the next, while keeping every possibility to sample the phase currents at the most appropriate instant without any ripple visible in the sampled values.

In OPP, a dynamic pattern change disturbs massively the predictability of the sampling points, if any.

Any ripple or error, measured in the phase currents, would propagate to the I_{DQ} signals, inducing variations in the applied modulation (either changing the pattern or changing the phase voltage, shifting the pattern forward or backward).

The quantity of disturbances injected in the regulation induces perturbations in the motor, with the risks of oscillations or divergences. Until now, the solution has been to strongly reduce the cut-off frequency of the regulation, to minimize the effects of those disturbance and avoid injecting them in the motor.

This was done at the cost of degrading the dynamic support of the regulation, making it slow.

Having clean input signals for the regulation would suppress any oscillation injection, improving the quality of the phase current signals and reducing losses in the motor (by limiting the injected harmonics strictly to the pattern contained harmonics).

The invention aims at providing solutions for the difficulty of sampling the motor phase currents while enabling using an OPP (Optimized Pulse Patterns) modulation non-limited as in the state of the art.

The invention provides regulating arrangements, control arrangements, motor arrangements and methods that can be employed therewith and/or leverage on particular devices such as trigger devices and/or filter devices being part of those arrangements, all of the foregoing suited for control of electric motors and especially take advantage from the interplay of the functionality said devices provide.

It is an first aspect of the invention to introduce in a regulating arrangement (suitable for being part of a control arrangement for electric motor, comprising a modulating device and a gate signal generating device) one or more trigger device for generating trigger signals for a (motor inverter) current measurement device for providing current measurements, being triggered by said trigger signals, said trigger device having one or more inputs (for receiving data from the regulating device and/or (motor) position measurement device and/or other information) and computation or calculating capabilities on said one or more inputs. This trigger device manages either a sampling at any time, whether periodically at a high frequency or asynchronously triggered by some predictive mechanisms. The predictive mechanism defines when to sample each phase current simultaneously or independently (e.g when each phases current crosses their respective current fundamental; e.g when Id/Iq ripple is null; etc), based on the regulation status and applied patterns on each phase.

It is an second aspect of the invention to introduce in a regulating arrangement (suitable for being part of a control arrangement for electric motor, comprising a modulating device and a gate signal generating device), wherein said regulating device may or may not perform one or more transforms (which may use position measurements) on current measurements, (optionally adaptive) filtering on said current measurements before or after their transformation, and computing said regulating signals based on said filtered transformed current measurements, wherein the filter parameters are determined by the setpoint (Torque, Speed) of the motor. Note that the filtering or related filter device can be part of a feedforward control arrangement wherein it acts as correcting by subtracting anticipated error on requested sampling instants.

A third aspect of the invention is that as the first and/or second aspect of the invention supports methods adapted for advanced modulation approaches like OPP, it results in optimal or improved currents measurements, by deciding whether the sampling will be done simultaneously or not for two or more of the phases. It is the use of said trigger device that can result in discarding sampling instants. It is the use of the (adaptive) filtering that can result in weighting (transformed) sampling instants.

The invention provides for a regulating arrangement (suitable for being part of a control arrangement for electric motor, comprising a modulating device and a gate signal generating device) comprising: a (motor) position measurement device for providing position measurements, a trigger device for generating trigger signals, a (motor inverter) current measurement device for providing current measurements, being triggered by said trigger signals; a regulating device for generating regulating signals using said current measurements and optionally said position measurement or position estimates, said position measurement device provides input signals to said trigger device and/or said regulating device (also) provides input signals to said trigger device.

In an embodiment of said invention said trigger device, based on said inputs of said regulating device (which provides the regulation status (phase shift) and optionally depending on the pattern (OPP)), calculates triggered angular locations for sampling the (phase) currents (simultaneously or independently), at the optimum instant.

In an embodiment of said invention said regulating device may or may not perform one or more transformations (which may use said position measurements) on said current measurements, (adaptive) filtering on said current measurements before or after their transformation, and computing said regulating signals based on said filtered transformed current measurements.

In an embodiment of said invention the filter parameters are determined by the setpoint (Torque, Speed) of the motor and/or the quality of the control to follow the command.

In an embodiment of the invention said trigger device takes into account said to be applied modulation, in particular supporting optimized pulse patterns-based modulation and hence wherein said trigger device takes into account said to be applied optimized (pulse) patterns in determining the trigger signals.

In an exemplary embodiment thereof said trigger device takes into account prior knowledge of the system indicating that sampling instants would bring more disturbance than information to the evaluation of the control signals (e.g. by discarding sampling instants).

In a further embodiment thereof said (adaptive) filtering takes into account prior knowledge of the system indicating that sampling instants would bring more disturbance than information to the evaluation of the control signals (e.g. by weighting sampling instants).

In another further embodiment said (adaptive) filtering takes into account prior knowledge of the system indicating the expected error in the control signals by correction (e.g. by subtracting anticipated error on requested sampling instants).

Note that the above embodiment or exemplary embodiment may be combined.

The invention further discloses an optimal or improved method for measuring currents (meaning determining their sampling instants) in a multi-phase inverter, more in particular deciding whether the sampling will be done simultaneously or not for two or more of the phases and/or periodic or not, the method comprising loading prior knowledge of the system indicating that sampling instants would bring more disturbance than information to the evaluation of the control signals; and determining decisions thereon.

Those methods may further anticipate the to be applied modulation (e.g. an OPP), its effect on the phase(s) current and determining decisions based thereon (the method comprising loading the to be applied modulation; and said determining decisions is also based thereon.

Those methods may further taking into account the possibility to compensate (error correction), weight and/or discard sampling instants.

It is worth noting if the embodiments of the patent are explained with a 2-level inverter (2 transistors per legs) the innovation also applies to multi-level inverter (more than 2 transistors per leg). It is further worth emphasizing that the embodiment of the patent is described for a 3 phase invertor but also the innovation applies for more phases.

### BRIEF DESCRIPTION OF THE DRAWINGS

FIG. 1 shows a typical digital controlled electric motor system wherein the invention can be exploited.

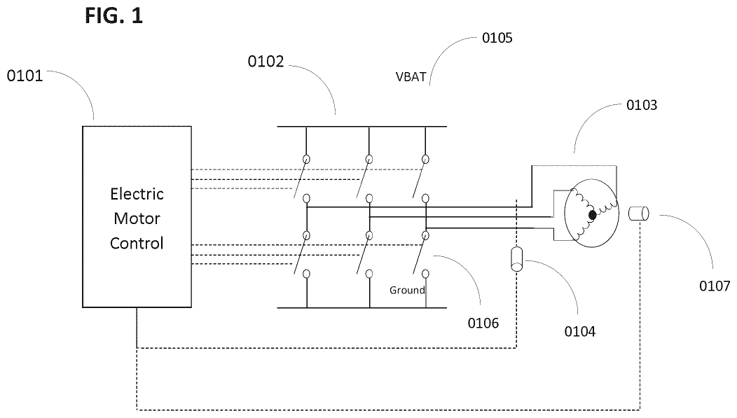

FIG. 2 illustrates a typical digital control logic.

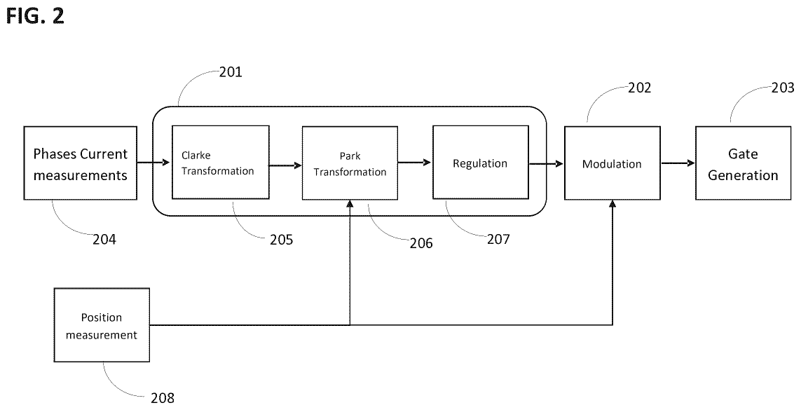

FIG. 3 illustrates the prior-art solution to the problem tackled by the invention.

FIG. 4 shows the results of applying the prior-art solution to the problem.

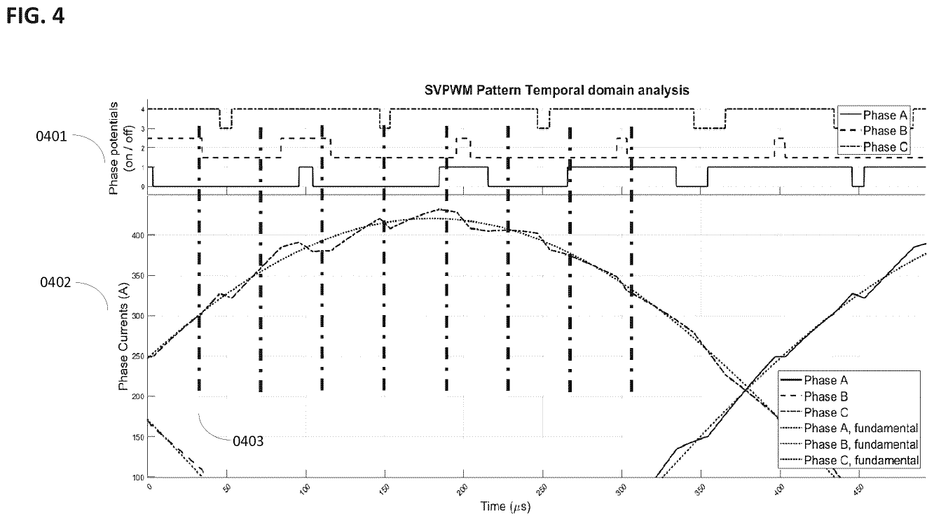

FIG. 5 shows various elements of the invention, which can be used separate or in combination.

FIG. 6 shows the results of applying the invented solution to the problem.

FIG. 7 shows one aspect of the invention—the trigger being fed with position measurements.

FIG. 8 shows an additional aspect of the aspect of FIG. 7—in that the trigger is also fed with position measurements.

### DETAILED DESCRIPTION OF THE INVENTION

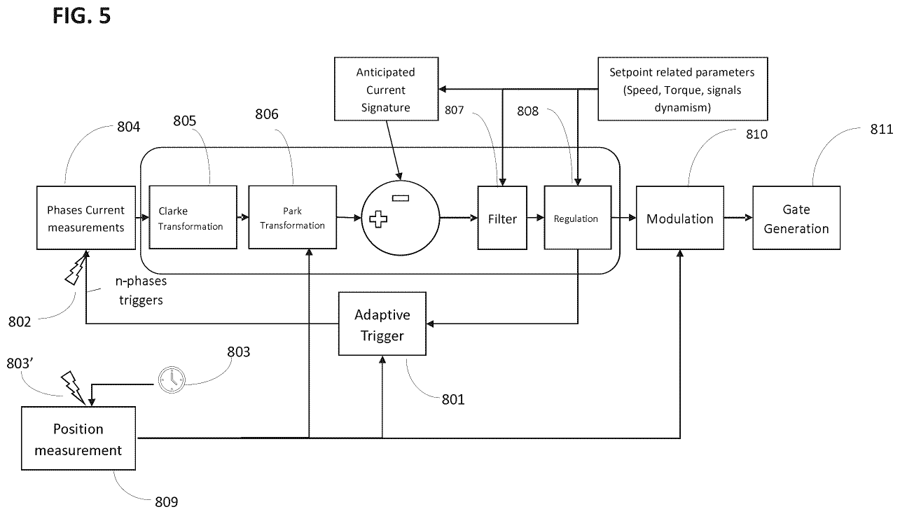

As a starting base for the description of the invention is it worth looking at FIG. 5 showing various elements of the invention, which can be used separate or in combination. In particular we see a trigger device, itself fed by position measurement data and used to trigger current measurements. Further we see that the position measurement can be used in the regulation, more in particular in the transformation. Alternatively, we observe that the trigger device can also receive data from the regulation. Further the invention describes that the parameters of the filter and/or regulator are setpoint dependent.

The trigger device enables asynchronously triggered phase current measurements which further enables dissociated sampling of the various phases (per phase approach). This supports methods wherein for each phase we have a fundamental estimation in combination with pure fundamental reconstruction (estimation of the signal without ripple).

The rationale behind the invention is now explained below.

In the field of the control of electric machines or motors, it is recognized that the deployment of certain (advanced) classes of control methods is seriously hampered because they require stringent measuring or sampling of the motor currents and therefore, absent satisfying such stringent requirements a priori putting limitations on these certain (advanced) classes of control methods is done in the field, hence disabling the use of their full (advanced) capability. Examples of such a priori limitations are one or more of the following: adding of (strong) constrains on the to be used patterns and (strong) reduction of the cut-off frequency of the regulation (which is part of the control loop).

The control methods considered are in the domain of Field oriented Control (FoC) regulation of synchronous motors, which are using the so-called Clarke and Park transformations, that require at least in theory simultaneous sampling of the phase currents.

For certain (basic) classes of control methods (like SVPWM or DPWM), the (optimal) sampling points can easily be predicted, even with an advantageous effect on the impact of disturbances (if you use those (optimal) sampling points and it is found to be sufficient to periodically sample the phase currents simultaneously for all phases in accordance with the working principle ((optimal) sampling points) of these control methods.

In the invention however, certain (advanced) classes of control methods (like OPP) are considered (possible in combination with the above mentioned control methods), wherein periodically sampling the phase currents and/or at simultaneously sampling those for all phases (for instance to obtain the above mentioned ripple free effect), are in principle not effective nor sufficient or even possible again unless a priori limitations are imposed. Indeed certain (advanced) classes of control methods in the invention are considered wherein disturbances like ripple and/or any other error causes severe perturbations which may lead to oscillations and/or divergences, hence this problem cannot be neglected.

In the invented approach, the above stringency problem is fully acknowledged but instead of putting a priori limitations, the deliberate choice is made to satisfy those stringent requirement, to deal with the consequences of this choice in terms of the hardware requirements for the hardware supporting the involved control methods and where possible prevent either that such consequences are too severe in terms of hardware (like required speed and/or memory) or by fundamentally tackling (by providing suitable filtering and/or advanced sampling methods as elaborated further below) the sensitivity of the considered control methods for ripple and/or any other error.

It is a first theme of the invention that the selected hardware is a (digital) control system comprises at least hardware going beyond a software programmable unit (like a micro-controller) such as a hardware (programmable) unit, preferably a programmable logic matrix (like an embedded FPGA), even more preferably such unit being provided with mathematical accelerators, targeted for computations as required by said stringent requirements.

It is a second theme of the invention, contrary to certain (basic) classes of control methods which intrinsic have the advantageous effect of being less sensitivity disturbances to handle a certain (advanced) classes of control methods which are vulnerable for disturbances like ripple and/or any other error by providing more clean signals (before the regulation part of the control method in particular) by providing appropriate filtering. This second theme of the invention leverages on the first theme in that the selected hardware is adapted for computations supporting such filtering. Note that for such filtering to be effective one requires to sample more (frequently) as compared with the use of the data in basic control methods and hence the hardware should be capable to handle this.

It is a third theme of the invention to try to determine or predict (in real-time) when such stringent requirements are actually needed or said otherwise also predict (optimal) sampling points (but now in view of the advanced control methods for which the measured or sampled motor currents will be used, preferably while using those control methods to their full extent, meaning not reverting to the a priori discussed limitations or at least considering a relaxed version of those limitations) while not longer in principle restrict to periodically and simultaneously sampling those for all phases.

In an embodiment of the invention the impact of disturbances at the sampling points is determined and this is brought in consideration for determining the (optimal) sampling points (which may even lead to discarding certain sampling points).

FIG. 5 shows the digital control logic details in accordance with the invention.
0801: High frequency trigger source, with optional predictive optimizations
0802: Phase current measurement trigger
0803: Periodic timer
0803′: Periodic trigger for position measurement
0804: Three phases current measurement from the motor
0805: Clarke to transform I_{A, B, C} currents to I_{alpha, beta}
0806: Park to transform I_{alpha, beta} currents to I_{D, Q} currents
0807: Adaptative Filter on current measurements after their transformation
0808: Regulation of I_{D} and I_{Q} currents
0809: Motor position measurement
0810: Modulation (e. g SVPWM, DPWM or OPP)
0811: Transistor gate signal generation for power stage control

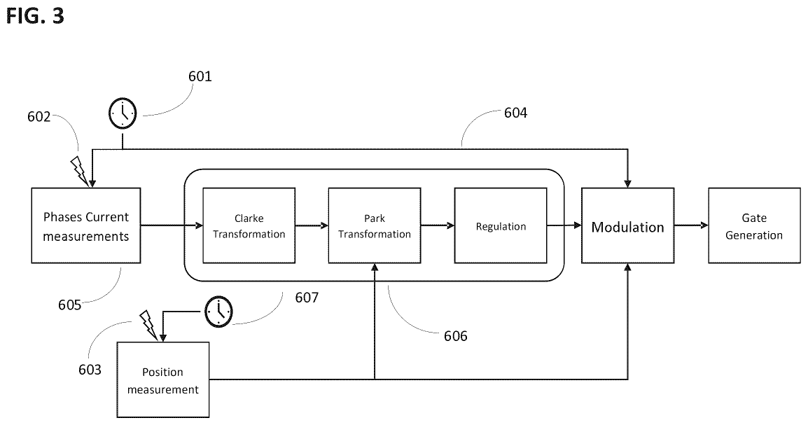

Note that contrary to FIG. 3 that the current measurement is triggered by a device, itself being triggered by the position measurements. Moreover the current measurement triggering device can also receive input from the regulation (feedback).

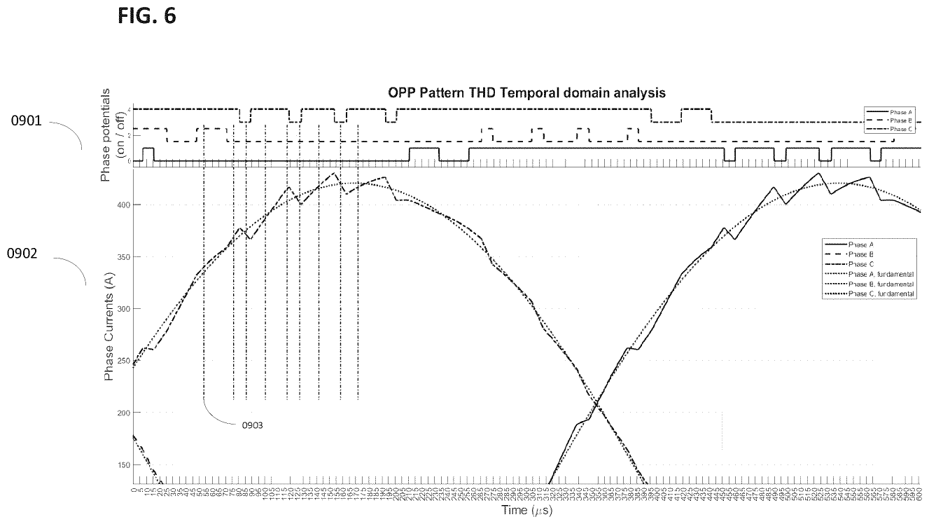

FIG. 6 shows the corresponding results.
(0901): Phase potentials with OPP patterns on all phases.
(0902): Phase currents exhibits, on average, a sinusoidal waveform with some ripple disturbances.
(0903): Sampling may happen at any sampling point, whether periodically at a high frequency or asynchronously triggered by some predictive mechanism.

The set-up as disclosed above enables one or more of the following uses.

A first use enabled by the set-up is to massively increase the number of available sampling points (by one or several orders of magnitude). At the upper limit a continuous sampling could take place. This, despite sampling the phase current ripple and injecting noise in the calculated EMotor current in the DQ-frame, will enable to have an average value close to the real signal average value. The simultaneous sampling of all phases can remain periodic, as with the Pulse Width modulation solution or it can also be irregular. This reduces the impact on the regulation as all phenomena inject mostly statistical disturbances located in a higher frequency range as the constant (or relatively slow dynamics) of the DQ-frame currents.

A second use is to prefilter the signals, either in the ABC, Alpha-Beta or DQ-frames, comparing them with theoretical or effective representations of themselves. Various types of filters can be applied, with or without prior knowledge of the signal or signal noise. Without any prior knowledge, filters such as PLL, PID, slewRate, or Kalman for examples, would be applicable. With prior knowledge, knowing the high periodic sampling frequency (or angular sampling frequency), the injected harmonics (pattern harmonics with spectral folding) and the regulation harmonics (refresh rate and constraints applied on regulation) can be anticipated; the prior knowledge could even be enriched with learning tests. All those information can help design a filter that is specifically dedicated to motor, a set point and/or more widely a set of patterns.

If the applied modulation can be anticipated (which is particularly true, in the case of OPP), it is also possible to estimate (offline or online) the phase current signals. This anticipated signature of the phase currents could serve as a regular error compensation, to remove the sampled ripple content from the fundamental signal. This subtraction will never fully remove all noise from the signal (as the regulation is evolving differently from expected or small delays/errors are present in the signal treatment chain).

However, the anticipated phase current ripple content represents the most part of our measured error. Removing it before any further filtering improves the signal quality.

The previously described strategy for sampling does not require any constraint to be applied on patterns during their generation, as it adapts to any pattern harmonic properties instead of placing requirements on them.

The previously described strategy for sampling is not solely applicable to OPP modulation but can be extended to any pulse width modulation, making it robust to non-negligible measurement errors: any electric instabilities or temporal delay in the sensors and ADC triggering, rendering the prior-art strategy inappropriate to obtain exact samplings. The described sampling strategy becomes applicable over all modulation strategies and can remain active even when switching modulation type.

This sampling strategy exhibit no limitations that would prevent it to be applied to electrical motors with any number of phases. Also, since this sampling strategy forces no constraint on the pattern design, it is fully capable to support regulation using OPP patterns for multi-level inverters.

The innovation is independent from the applied set point (Torque, Speed), and can be made resilient to anticipated or unpredicted accelerations. It is also compatible with OPP patterns with varying number of edges (low or high equivalent switching frequency). It can be made time-dependent or angular dependent and carried safely over multiple modulation strategies.

The strategy can be further improved by weighting the sampling instants, when prior knowledge of the system indicates that sampling instants would bring more disturbance than information to the evaluation of the control signals. At the extreme end of the spectrum, this means some sampling instants could be fully discarded.

The strategy can be further improved by designing filters dedicated to the noise injected using patterns. Whether the noise spectrum is predicted or measured online, various filter structures or configurations will help eliminate precisely the frequential ranges that contain no useful information.

The above strategy imposes an implicit constraint on the logic to transform and filter the phase current in control signals. Such high frequency sampling and statistical filtering strategy is difficult to execute on random micro-controller. Therefore, the innovation is perfectly suited for an execution on a FPCU component that provides an embedded FPGA and various mathematical accelerators, for hard real time sequences.

Note that while the prior-art and embodiments of the invention are illustrated for a regulation modulation approach wherein the Park transform also inputs position measurements, that this is not a requirement. Moreover, the use of the position measurements can also be alleviated to the level of the regulation-modulation, in that one or more of the other blocks therein such as the Clarke transform, the filter, the modulator, up to the gate (signal) generation may use those as well.

Note that while the prior-art and embodiments of the invention are illustrated for a regulation modulation approach with a single regulator and a single modulator, the same can be applied to configurations with multiple regulators and/or multiple modulators.

### In Summary

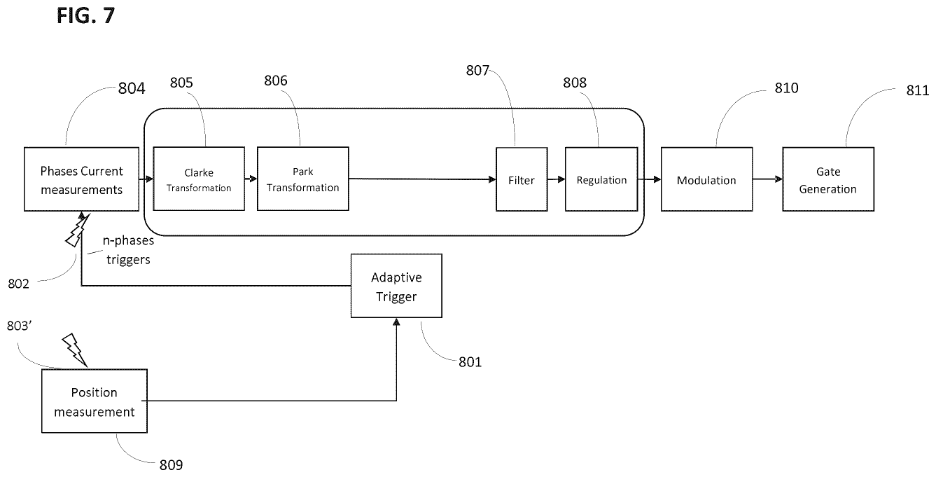

FIG. 7 shows a regulating arrangement for electric motor control, comprising: a motor position measurement device for providing position measurements, a trigger device for generating trigger signals, a motor inverter current measurement device for providing current measurements, being triggered by said trigger signals; a regulating device for generating regulating signals using said current measurements, said position measurement device provides input signals to said trigger device. The position measuring itself can be triggered either by a timer and/or invoked by other signals generated in the arrangement or even outside the arrangement.

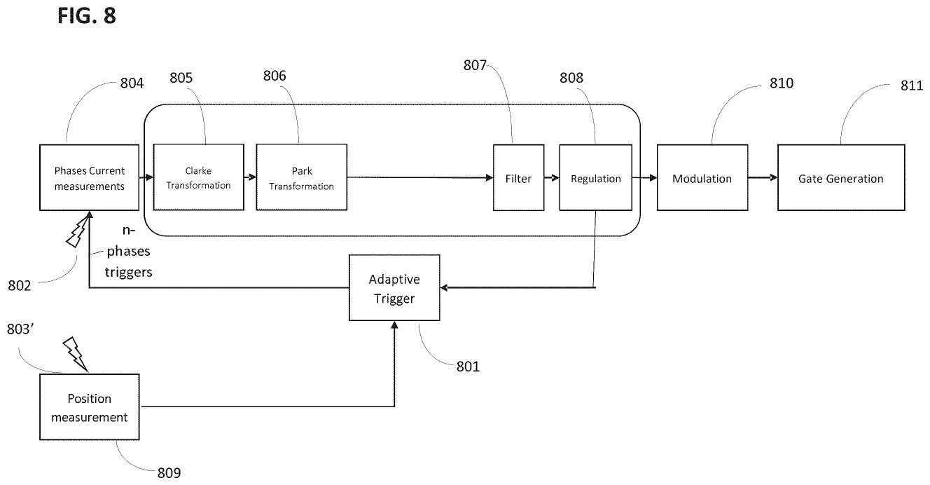

FIG. 8 shows that said regulating device also provides input signals to said trigger device.

Further the invention discloses that the trigger and/or filter device are running methods and which lead to discarding sampling instants (by the trigger device by not triggering) or if sampled compensate, weight sampling instants (by the filter device), these methods evaluate whether that particular use of that sampling instants would bring more disturbance than information to the evaluation of the control signals; and determining decisions based thereon.

1. A regulating arrangement for electric motor control, comprising:
a motor position measurement device configured to generate position measurements;
a trigger device configured to generate trigger signals;
a motor inverter current measurement device configured to provide current measurements in response to trigger signals; and
a regulating device configured to generate regulating signals using the current measurements and/or the position measurements, and to provide input signals to the trigger device.

2. The regulating arrangement of claim 1, wherein the regulating device is further configured to provide input signals to the trigger device.

3. The regulating arrangement of claim 2, wherein the trigger device is further configured to calculate triggered angular locations for sampling the currents based on the inputs of the regulating device.

4. The regulating arrangement of claim 1, wherein the current measurement device is further configured to provide current measurements from a plurality of phases of the electric motor, and wherein the triggering of current measurements is independent per phase.

5. The regulating arrangement of claim 1, wherein the regulating device is further configured to perform any of one or more of: transformations on the current measurements, adaptive filtering on the current measurements before or after their transformation, or computing the regulating signals based on the filtered transformed current measurements.

6. The regulating arrangement of claim 5, wherein the filter parameters are determined at least by a setpoint of the motor.

7. A control arrangement for an electric motor, comprising:
a modulating device;
a gate signal generating device; and
the regulating arrangement of claim 1;
wherein the position measurements are used within the modulating device.

8. A motor arrangement, comprising:
an electric motor;
a multi-phase inverter; and
the control arrangement of claim 7;
wherein said position measurements are measuring the position of the electric motor and the current measurements are taken from the inverter.

9. The control arrangements of claim 7, wherein the trigger device is further configured to determine the trigger signals based on a modulation that uses optimized pulse patterns.

10. The regulating arrangements of claim 1, wherein the trigger device is configured to consider prior knowledge indicating that sampling instants would bring more disturbance than information to the evaluation of the control signals.

11. The regulating arrangement of claim 5, wherein the regulating device is configured to perform the adaptive filtering by taking into account prior knowledge of a system indicating that sampling instants would bring more disturbance than information to the evaluation of the control signals.

12. The regulating arrangement of claim 5, wherein the regulating device is configured to perform the adaptive filtering by taking into account prior knowledge of a system indicating an expected error in control signals by correction.

13. The regulating arrangement of claim 5, wherein the regulating device is configured to perform the adaptive filtering by an electronic component adapted for streaming data, wherein the electronic component is or comprises a digital control system comprising a hardware programmable unit or a programmable logic matrix.

14. A method for improved measuring of currents, comprising:
loading prior knowledge of a system indicating that sampling instants would bring more disturbance than information to the evaluation of the control signals; and
determining decisions thereon.

15. The method of claim 14, further comprising:
anticipating a modulation to be applied;
anticipating an effect on a phase current; and
determining decisions based thereon.

16. The method of claim 14, further comprising taking into account a possibility of compensating weight and/or discarding sampling instants.

17. A non-transitory computer readable medium comprising instructions that, if executed by a processor, are configured to cause the processor to:
load prior knowledge of a system indicating that sampling instants would bring more disturbance than information to the evaluation of the control signals; and
determine decisions thereon.

18. The regulating arrangement of claim 4, wherein the regulating arrangement has a plurality of trigger devices assigned to each phase.
